(19) United States
(12) Patent Application Publication
(10) Pub. No.: US 2023/0000087 A1
(43) Pub. Date: Jan. 5, 2023

(54) ENDOPHYTIC STRAIN OF CLONOSTACHYS ROSEA FOR BIOCONTROL OF PHYTOPATHOGENIC FUNGI

(71) Applicant: FUNDACIÓN UC DAVIS - CHILE LIFE SCIENCES INNOVATION CENTER, Santiago (CL)

(72) Inventors: Álvaro CASTRO OYARZÚN, Santiago (CL); Isidora SILVA VALDERRAMA, Santiago (CL)

(21) Appl. No.: 17/757,206

(22) PCT Filed: Sep. 16, 2020
(86) PCT No.: PCT/CL2020/050107

§ 371 Date: Jun. 10, 2022

(30) Foreign Application Priority Data
Dec. 11, 2019 (CL) 3618-2019

(51) Int. Cl. A01N 63/30

(52) U.S. Cl. CPC A01N 63/30

(57) ABSTRACT

The invention relates to a biocontroller product of phytopathogenic fungi, specifically to a biocontrol composition which comprises an endophytic strain of Clonostachys rosea R36.1, CChRGM 989 (entry), CChRGM 2905. Where this specific strain has the ability to control phytopathogenic fungi associated with wood diseases, especially vine wood such as Neofusicoccum parvum, Diplodia seriata and Phaeomoniella chlamydospora, among others.

And a method to prevent and control fungal diseases in plants that includes applying the biocontrol composition comprising the previously described Clonostachys rosea strain R36.1 CChRGM 2905 in a plant susceptible to developing a fungal infection.

### FIELD OF THE INVENTION

The present invention relates to the agricultural industry, especially in the cultivation of vines. In particular, the present invention relates to a product and a method for the biocontrol of fungal diseases of wood, using for this an endophytic strain of the fungus Clonostachys rosea, R36.1. (Deposit CChRGM 989 (entry), CChRGM 2905, 25 Nov. 2019).

### BACKGROUND OF THE INVENTION

Within wood diseases mediated by fungi, the diseases of the wood or the trunk of the vine (Vitis vinifera L.) have special relevance, since GTD, (Grapevine Trunk Diseases) are one of the biggest problems for the wine and table grape industry worldwide. GTD decrease the longevity of the vineyard and reduce the productivity and quality of the grapes, which leads to higher production costs. Additionally, it should be considered that fungi associated with GTD can also infect the wood of other crops, with apple trees, eucalyptus, almond trees, avocados and peaches, among the most affected, but also in plants in general, such as flowers, ornamental plants, fruit vegetables, hydroponic crops, leafy vegetables and cabbage crops, pome fruits, deciduous trees, vines, citrus fruits, pines, stone fruits, nuts, grains and herbs.

The fungi that cause GTD often infect established vines through wounds produced by annual pruning. However, these fungi have also been detected in propagating material and grafted young plants. Therefore, GTD could spread during plant multiplication, colonizing the material even before they reach the field.

Chile is the fourth largest wine exporter in the world. With more than 182,000 productive hectares planted, the wine industry is considered one of the most important economic activities in the country. However, in 2013, it was reported that around 22% of vineyards in Chile showed symptoms of GTD. Given the exponential spread of these diseases, it is believed that about 75% of the vineyards would be affected today, being considered as one of the main phytosanitary problems of the industry. The most frequently isolated fungi, from affected and symptomatic plants in Chile, are Phaeomoniella chlamydospora, Diplodia seriata, Inocutis sp. and Neofusicoccum parvum.

The main concern regarding GTD is that once the plant tissue is colonized, there is no effective removal treatment for these fungi. Some preventive practices have been proposed, such as coating formulations with fungicides or natural antifungal compounds that are applied to pruning wounds, and double pruning practices that could reduce the impact of the disease. However, these strategies have a variable efficacy since they do not keep the plant protected for the necessary time during which it is still susceptible. In addition to their variable efficiency, they have a high cost due to the requirements of continuous applications and, in addition, they may not be friendly to the environment, for example, by washing the product from the wounds into the ground during the rainy season.

In short, at present, there are no tools available to effectively cure the disease. The common procedure in the field is the removal of the diseased plant so that it does not contaminate its neighbors.

Faced with this scenario, the inventors focused on developing a product using a biocontrol agent, since biological agents, by remaining alive in the plant, provide longer periods of protection, and are both selective and harmless to the environment, compared to conventional treatments with chemical fungicides. For this, the inventors selected antagonist fungi of the main phytopathogenic fungi of vine wood (GTD) looking for those that would carry out an effective biocontrol of them. Since pathogens are found inside the plant, endophytic fungi were sought with special interest since they share the same niche with these phytopathogens.

Surprisingly, the inventors have selected an endophytic strain, that is, isolated from the interior of the plant, of the species Clonostachys rosea that has shown a great capacity for biocontrol of pathogenic fungi of vine wood such as Neofusicoccum parvum, Diplodia seriata and Phaeomoniella chlamydospora, for example.

In the state of the art there are biocontroller products that use other strains of Clonostachys rosea, either alone or in combination with other biocontrollers.

For example, patent EP3044307 (B1) describes a product that is similar to the present invention, where a Clonostachys rosea strain is protected, which is useful mainly for controlling fruit diseases, such as Botrytis sp. There is no evidence that this strain has effects on fungi that affect wood, in fact, this document does not challenge, nor does it indicate as possible targets, fungi that affect wood, as the strain of the invention does.

On the other hand, the PCT application WO2019130241 (A1), of the Universidad de Chile (University of Chile), discloses a mixture of Trichoderma harzianum and Clonostachys rosea which also allows the control of wood fungi. However, no particular strain is characterized, and the solution disclosed in said document depends on a mixture of biocontrollers, not only on one strain, as in the case of the present invention.

In this way, the invention appears as a new alternative for the effective disease control of vine wood (GTD), employing only one type of microorganism, so it is of a simpler handling than a mixture that must maintain specific proportions, and as will be seen in the examples has a high effectiveness of biocontrol.

### DESCRIPTION OF THE FIGURES

FIG. 1. Recovery of the pathogens D. seriata and N. parvum after different treatments in autoclaved pruning material (A.) and unsterilized pruning material (B.). The treatments used were water, the fungicide Tebuconazole and the strain of the invention C. rosea R36.1. Inoculation with the pathogen occurred 24 hours after being treated. Results are shown after 7 days of incubation, 0.5 and 2.5 cm away from the point of inoculation of the corresponding pathogen.

FIG. 2. Growth of the pathogens D. seriata and N. parvum in PDA plates in dual culture with the antagonists Purpureocillium sp., Chaetomium sp., Trichoderma sp., Epicoccum sp., and three strains of C. rosea among which is the strain of the invention. The measurement of the growth area was performed on day 14 of the trial.

### DESCRIPTION OF THE INVENTION

The invention relates to a biocontroller product of phytopathogenic fungi, specifically to a biocontrol composition comprising an endophytic strain of Clonostachys rosea R36.1, CChRGM 2905. The inventors have determined that this specific strain has the ability to control phytopathogenic fungi associated with wood diseases, especially vine wood diseases such as Neofusicoccum parvum, Diplodia seriata and Phaeomoniella chlamydospora, among others.

Inventors have found that this strain has an antibiotic capacity, and at the same time an ability to co-repress other fungi, so it would attack with more than one mechanism the pathogens present in the plant tissue.

For the expert in the technique it will be evident that the most efficient way to apply a strain of a biocontroller fungus is a composition with its propagation material, in this case the conidia.

The biocontrol composition of the invention comprises, in addition to the conidia of the strain of the invention, an appropriate vehicle, which is selected from the group consisting of water, aqueous solutions, thick suspensions, granules and powders. In addition, the composition of the invention may contain other biocontroller strains of the same species or another, and/or additives selected from the group consisting of fertilizer, insecticide, fungicide, nematicide surface-active substances, UV protection systems and mixtures thereof.

In a second aspect, the invention points to a method to prevent and control fungal diseases in plants which includes applying the biocontrol composition comprising the endophytic strain of Clonostachys rosea R36.1, CChRGM 2905, in a plant susceptible to developing a fungal infection; where plant disease is especially wood disease, especially the vine, where the pathogen belongs especially to species such as Neofusicoccum parvum, Diplodia seriata and other species of the Botryosphaereacea family, Phaeomoniella chlamydospora and Botrytis cinerea, for example. The plant to be protected is selected from the group consisting of flowers, ornamental plants, fruit vegetables, hydroponic crops, leafy vegetables and cabbage crops, pome fruits, deciduous trees, vines, citrus fruits, pines, stone fruits, nuts, grains and herbs. The plants to be treated are especially vines.

The application of the composition of the invention is carried out by any method available in the technique, such as: spraying, liquid or dry application in furrows, soaking of plant material, on wounds of pruning cuts, direct incorporation into soils or planting mixtures in greenhouses, pots, fields, granular formulations or granules, or direct treatment of seeds or propagating material or grafts.

Where the composition of the invention is preferentially applied in the form of a suspension comprising between 1×10⁴ to 1×10⁹ total conidia per milliliter.

The composition may contain other formulation adjuvants, such as surface-active substances, UV protection systems, adherents, dispersants, disintegrators, wetting agents, among others.

### APPLICATION EXAMPLES

### Example 1. Obtaining a Composition of the Invention

The strain of the invention was isolated from the interior of vine roots, identified by ITS as Clonostachys rosea and deposited under the deposit number CChRGM 2905 in the Chilean Collection of Microbial Genetic Resources.

Liquid culture media were evaluated for the production of conidia by the strain. An inoculum of 1×10⁴ of the strain of the invention was added to conical tubes with 30 mL of PDb (potato broth dextrose, 24 gL⁻¹), MEb (broth malt extract 15 gL⁻¹), MEb with addition of sodium (MEb modified with 0, 85% NaCl). The samples were incubated at 25° C. with a stirring of 170 rpm at an angle of 45° with the caps loose for 10 days. This experiment was repeated 5 times.

Samples were collected from each tube in duplicate and the conidia were counted with a Neubauer chamber.

The production of C. rosea R36.1 conidia was higher in the PDb broth medium, followed by MEb. The conidial concentration obtained in PDb (1.4×10⁸ conidia mL⁻¹), was 7 times higher than the best conidial production in any of the other media evaluated.

With the conidia produced under any of the conditions indicated, the formulation of the invention can be obtained at a concentration of 1×10⁶ conidia mL⁻¹ and an agronomically appropriate vehicle such as water.

### Example 2. Effect of Clonostachys rosea R36.1 on the Growth of GTD Fungi in Pruning Material

An in plantae trial was conducted to evaluate the fungal antagonist effect on GTD fungal growth. Internode sections of the annual vine pruning material (rods) were cut into 4.5 cm lengths and then autoclaved for 25 minutes at 121° C.

Inoculation with Clonostachys rosea was carried out by adding 40 μl of fresh conidia suspension (1×10⁶ mL⁻¹ conidia) of antagonist ensuring that the suspension covered all the rods by capillarity. As a control, in parallel experiments tebuconazole was applied (recommended field dose of 60 ml/100 L) or sterile distilled water with the same procedure.

This experiment was carried out 5 times. The rods of annual material were incubated in individual wet chambers for 24 hours.

Then, we proceeded to challenge N. parvum and D. seriata with the pathogen, for which 10 μl of suspension of mixture of conidia and fresh mycelium of each of the pathogens were inoculated separately at the same end of each rod where it had been inoculated previously with the strain of the invention; and were immediately placed in a horizontal position, avoiding the diffusion of the suspension by the plant material.

The rods with the treatment and pathogen were incubated in wet chambers for 7 days. Subsequently, the surface of the pruned vine material was disinfected by rubbing with 70% ethanol. With a sterile hot scalpel, the bark and 0.5 cm from the ends of each rod were removed. Small sections of plant material located at 0.5 and 2.5 cm from the pathogen's inoculation point were collected and cultured in individual PDA (potato dextrose agar) plates at 25° C. for 7 days. In this way, it was possible to evaluate the progress of each pathogen through the pruning material with the 3 treatments.

To assess the viability of the pathogen's conidia and mycelium suspension, 10 μl of the solution was inoculated on one side of the piece of wood as described above and that was immediately processed to obtain small pieces at 0.5 and 2.5 cm from the pathogen's inoculation point. Each piece was grown in PDA at 25° C. for 7 days.

The presence of pathogens in solid culture was evaluated under a microscope.

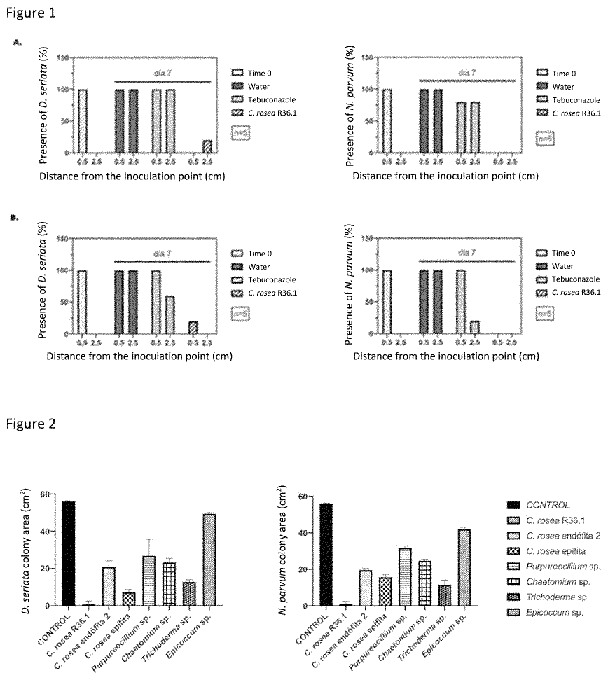

The antagonist strain of the invention C. rosea R36.1 was recovered in all samples co-inoculated with pathogens after 7 days. The results obtained are shown in FIG. 1A, where it is observed that the strain of the invention completely inhibited the development of the pathogen N. parvum, while Tebuconazole inhibited only 25% with respect to the water control. On the other hand, the strain of the invention shows 100% inhibition at the point closest to inoculation with D. seriata (0.5 cm) and 90% inhibition at 2.5 cm from the point of inoculation. Conversely, the fungicide Tebuconazole shows no inhibition of the pathogen D. seriata.

Additionally, bioassays were also performed on natural pruning material without a sterilization process. Sections of 4.5 cm in length were inoculated in their entirety with 40 uL of fresh conidia of C. rosea R36.1 (1×10⁶ conidia mL⁻¹). The fungicide Tebuconazole (recommended field dose of 60 ml/100 L) was used as a control, as well as sterile distilled water under the same procedure.

After 24 hours, the pruning material was inoculated with 10 μl of suspension of conidia mixture and fresh mycelium of N. parvum and D. seriata separately at the same end of each rod where the strain of the invention had previously been inoculated; and was immediately placed in a horizontal position, avoiding the diffusion of the suspension by the plant material. The pruning material was incubated in wet chambers for 7 days.

After incubation, the surface of the sections was disinfected with 70% ethanol. Using a sterile hot scalpel, the bark and 0.5 cm from the ends of each rod were removed. Small sections of plant material located at 0.5 and 2.5 cm from the pathogen's inoculation point were collected and grown in individual PDA (potato dextrose agar) plates at 25° C. for 7 days for the advancement of each pathogen through the pruning material.

As a control, the viability of the suspension of conidia and mycelium of the pathogen was evaluated. Ten μl of the suspension of each pathogen was inoculated on one side of the piece of wood as described above and that was immediately processed to obtain small pieces at 0.5 and 2.5 cm from the inoculation point. Each piece was grown in PDA at 25° C. for 7 days. The presence of pathogens in solid culture was evaluated under a microscope. The results are shown in FIG. 1B.

The pathogens were able to colonize the entire piece in 7 days when they were not previously treated. As can be seen in the figure, the strain of the invention completely inhibited the development of the pathogen N. parvum, while the fungicide Tebuconazole was effective only at 2.5 cm from the point of inoculation. As for the other pathogen evaluated, D. seriata, 100% inhibition is observed in the section furthest from the inoculation point (2.5 cm) and 90% inhibition at 0.5 cm from the inoculation point. Conversely, Tebuconazole showed no inhibition of the growth of the pathogen D. seriata at 0.5 cm, and only 40% inhibition at 2.5 cm.

These results demonstrate that the strain of the invention is able by itself to inhibit the growth of pathogens in plant material.

### Example 3. Evaluation of the Antagonistic Mechanism of the Strain of the Invention

To assess the mode of action of C. rosea strain R36.1, microscopic observations were made of the mycelium of the pathogenic fungi and the strain of the invention confronted in the area of interaction in petri dishes where a disc of agar of 5 mm of pathogen culture was placed on one side of a Petri dish with PDA (39 g L⁻¹; Difco) or AA (water agar 20 gL⁻¹) and on the opposite side a disc of agar of 5 mm containing la cultivated strain of the invention was placed. The plates were incubated at 25° C. until the mycelium of both fungi was in contact or formed an inhibition halo.

When the endophytic C. rosea strain of the invention was confronted with the pathogens D. seriata or N. parvum, a halo of 15 to 20 mm surrounding the antagonist colony prevented the pathogen from growing larger and reaching the hyphae of Clonostachys.

In another trial, plates with PDA (39 g L⁻¹; Difco) with the surface covered with cellulose paper where a 5 mm mycelium agar disc of the antagonist was inoculated. After 7 days of incubation at 25° C., the paper was removed along with the C. rosea mycelium and a disc of mycelium agar of the same size as the pathogen in the center of the plate was inoculated on the same plate. The potential antibiotic compound from C. rosea showed inhibition over 47.2% of the growth of D. seriata and 50.1% of that of N. parvum.

Based on this result, the inventors deduce that what inhibits the growth of the pathogen, is an antibiotic compound secreted to the medium by the strain of the invention.

However, once the pathogen made contact with the hyphae of the antagonist, it was possible to observe under an optical microscope, a coiling of the hyphae of C. rosea over those of the pathogen at various points. Based on the literature and what was observed under the microscope, the inventors deduce that the coiling is given by the ability of the strain to mycoparasitize the pathogen. This, since the coiling is the step prior to the penetration of the hyphae of the pathogen, which generates cell death.

### Example 4. Comparative Advantages of the Strain of the Invention

In order to demonstrate the advantages as an antagonist of the strain of the invention with respect to other biocontroller microorganisms, se evaluated in agar the ability to antagonize and stop the growth of phytopathogens D. seriata and N. parvum of several known biocontrol agents: Purpureocillium sp., Chaetomium sp., Trichoderma sp., Epicoccum sp., and three strains of C. rosea among which is the strain of the invention.

For which a 5 mm mycelium disc of each antagonist obtained from the growth edge of the colony was positioned 1 cm from the edge of a plate with diluted PDA (19 g L⁻¹; Difco). At the opposite end, a mycelium disc of the same size of D. seriata or N. parvum was placed. The plates were left incubating for 14 days at 25° C. Subsequently, the area of the colony of the pathogen was measured. This trial was conducted in fivefold. The results are shown in FIG. 2.

After this time, it was possible to observe that the strain of the invention generated an inhibition of the growth of both pathogens of 98%, on average while the other strains of C. rosea evaluated and the other microorganisms evaluated Purpureocillium sp., Chaetomium sp., Trichoderma sp. and Epicoccum sp. presented much lower inhibitions than this, between 10% and 80% approximately, as shown in FIG. 2. This shows that the strain of the invention has its own effect, not anticipatable, which is not obtained by any microorganism of the same species, nor by other biocontrolling microorganisms, on the fungi responsible for wood diseases, such as D. seriata and N. parvum.

These examples should be considered as illustrative and not limiting to the present invention, which is fully defined in the accompanying claims.

1. A biocontrol composition for phytopathogenic fungi CHARACTERIZED in that it comprises Clonostachys rosea strain R36.1, CChRGM 2905 and an agronomically appropriate vehicle.

2. The biocontrol composition of claim 1, CHARACTERIZED in that it comprises a suspension of conidia of Clonostachys rosea strain R36.1 in a concentration between 10⁴ and 10⁹.

3. The biocontrol composition of claim 2, CHARACTERIZED in that the vehicle is selected from the group consisting of water, aqueous solutions, thick suspensions, granules and powders.

4. The biocontrol composition of claim 1, CHARACTERIZED in that the biocontrol composition additionally comprises other biocontroller microorganisms of the same species as another.

5. The biocontrol composition of claim 1, CHARACTERIZED in that the biocontrol composition additionally comprises additives selected from the group consisting of fertilizer, insecticide, fungicide, nematicide, surfactants, UV protection systems and mixtures thereof

6. A method to prevent and control fungal diseases in plants CHARACTERIZED in that it includes applying the biocontrol composition comprising Clonostachys rosea strain R36.1 CChRGM 2905 according to claim 1 in a plant susceptible to developing a fungal infection.

7. The method of claim 6, CHARACTERIZED in that plant disease is mediated by fungi of species such as Neofussicoccum parvum, Diplodia seriata and other species of the Family Botryosphaereacea, Phaeomoniella chlamydospora and Botrytis cinerea

8. The method of claim 6, CHARACTERIZED in that the plant is selected from the group consisting of flowers, ornamental plants, fruit vegetables, hydroponic crops, leafy vegetables and cabbage crops, pome fruits, deciduous trees, vines, citrus fruits, pines, stone fruits, nuts, grains and herbs.

9. The method of claim 8, CHARACTERIZED in that the plants to be treated are vines.

10. The method of claim 6, CHARACTERIZED in that the application is carried out by: spraying, liquid or dry application in furrows, soaking of plant material, on wounds of pruning cuts, direct incorporation into soils or mixtures of planting in greenhouse, pots, fields, granular formulations or granules, or direct treatment of seeds or propagating material or grafts.

11. The method of claim 6, CHARACTERIZED in that the biocontrol composition comprising Clonostachys rosea strain R36.1 CChRGM 2905 is applied in the form of a suspension comprising between 1×10⁴ to 1×10⁹ total conidia per milliliter.
